(19) United States
(12) Patent Application Publication
(10) Pub. No.: US 2026/0160912 A1
(43) Pub. Date: Jun. 11, 2026

(54) METHODS AND SYSTEM FOR ATTENUATING INTERFACE WAVES IN FULL WAVEFORM INVERSION

(71) Applicant: CGG SERVICES SAS, Massy Cedex (FR)

(72) Inventors: Jian CAO, Villebon-sur-Yvette (FR); Daniela DONNO, Paris (FR); Gilles LAMBARE, Saint Fargeau-Ponthierry (FR)

(21) Appl. No.: 19/405,690

(22) Filed: Dec. 2, 2025

Related U.S. Application Data
(60) Provisional application No. 63/728,336, filed on Dec. 5, 2024.

(51) Int. Cl. G01V 1/34; G01V 1/30; G01V 1/32; G01V 1/36

(52) U.S. Cl. CPC G01V 1/345; G01V 1/307; G01V 1/32; G01V 1/364; G01V 2210/42; G01V 2210/66; G01V 2210/67

(57) ABSTRACT

A method for inverting seismic data in elastic full waveform inversion (FWI) includes receiving recorded seismic data; calculating a wavefield with an attenuated interface wave uₛ based on an attenuation term that describes a wave attenuation along a travelling direction, wherein the attenuated interface wave uₛ corresponds to a wave traveling along a low-velocity guide or along an interface between two different media and the travelling direction is aligned with the interface; calculating an updated velocity model using (1) the wavefield corresponding to the attenuated interface wave uₛ and (2) a body wave wavefield u_{b}; and generating an image of a subsurface based on the updated velocity model of the subsurface.

### BACKGROUND OF THE INVENTION

### Technical Field

Embodiments of the subject matter disclosed herein generally relate to a system and method for imaging a subsurface. The system calculates a subsurface model based on a Full Waveform Inversion (FWI), and more particularly attenuates interface waves for the FWI model.

### Discussion of the Background

Seismic data is acquired to generate a profile, such as an image or a velocity model, of a geophysical subsurface structure. While a profile does not provide an accurate location for a desired resource (e.g., oil and gas) reservoir, it suggests, to those trained in the field, the presence or absence of a resource reservoir. Thus, providing a high-resolution profile of the subsurface prior to drilling a well or for exploration purposes of an existing well is an ongoing process in the natural resources exploration field.

One may acquire seismic data for generating a subsurface image or model in various ways, for example, with land equipment, marine equipment, ocean bottom equipment, autonomous underwater equipment, or aerial equipment. The sensors and sources used in any of these scenarios are known in the art and thus, a detailed description is not repeated here. The recorded seismic data d may be acquired with a system 100 as illustrated in FIG. 1. FIG. 1 schematically illustrates a seismic survey system 100 including a source S and a receiver R located on the surface 110. A reservoir 112 is schematically illustrated in the subsurface 114. A wave 120 emitted by the source S reflects from the reservoir 112, and the receiver R records its reflection 122. The figure also shows an interface wave 124 that propagates along an interface between the ground 114 and the air 116 to the receiver R. A surface wave typically propagates along an interface between a medium, e.g., a layer of the Earth, and the air. The surface wave is also referred to as “an interface wave.” However, the interface wave is a more general term that refers to any wave propagating along the boundary (interface) between two different media, not limited to the ground/air surface. In other words, interface waves can occur at any interface, not just the Earth's surface. Thus, the interface waves include surface waves but may also encompass guided waves that travel along interfaces or layers within the subsurface, such as a low-velocity layer sandwiched between higher-velocity layers. The following embodiments are discussed with regard to the surface wave but one skilled in the art should understand that any embodiment or scenario involving a surface wave equally applies to an interface wave.

After acquiring the seismic data, one may process it to eventually generate the subsurface image. Many known algorithms exist for processing the acquired seismic data. Migration is one such algorithm used for seismic data analysis. Migration allows for correctly positioning subsurface structures and reflectivity. However, some existing migration methods generate images that may lack resolution, exhibit bad event continuity, and show zones with dimmed amplitude, due to band-limited sources and uneven illumination patterns of seismic waves.

One further processes signals associated with the recorded seismic waves to obtain an image of underground geologic features. A seismic signal level, which corresponds to the recorded seismic waves, may be small and can easily blend with noise or problems related to the acquisition.

The Least-Squares Migration (LSM) method may partially overcome these limitations. LSM is a more robust inversion method that minimizes the misfit between the observed or recorded seismic data d and synthetic data generated by an inverted reflectivity. However, LSM relies on a linear assumption between reflectivity and recorded seismic data, which may not provide a good approximation in complex geological settings.

Another method used in the field is the acoustic FWI. Acoustic FWI is a method used to obtain models of subsurface physical properties, such as velocity or density. It achieves this by solving a minimization problem that uses the full wavefield information from the recorded seismic data d. Unlike LSM, acoustic FWI does not presuppose linearity and thus may model more physical phenomena and handle the subsurface's geological complexity better. With advances in computing power, FWI has increasingly become a main component for the oil and gas industry during exploration and production phases, delivering high-resolution models with useful information for reservoir interpretation.

However, applying acoustic FWI to land data and very-shallow water (e.g., a water column less than 100 m, but also to deeper water situations) has proven very challenging. The main difficulties are linked to a greater influence of elastic wave phenomena in these data sets, especially for those characterized by strong elastic property contrasts in the near surface, as in the Middle East. Although several acoustic FWI applications have demonstrated this technology's potential, when recorded land data is affected by strong elastic effects like primary-to-secondary (P-to-S) conversions (i.e., a conversion of a P-wave, at an interface, into an S-wave), and energetic surface waves, one requires dedicated data preconditioning for running acoustic FWI. Note that the P-waves are compressional or longitudinal waves while the S-waves are shear or transverse waves.

For example, the authors in one article (see, Guo and Aziz, 2024) found that acoustic FWI applications on land seismic data face significant challenges, particularly in regions like the Sultanate of Oman, due to complex near-surface effects. These effects generate strong ground roll and heavy multiple reverberations, which can obscure data and limit the effectiveness of velocity model updates, especially for deeper targets. To address these issues, methodologies may incorporate advanced data pre-conditioning and more detailed initial velocity model. For instance, in northern Oman, techniques such as matching pursuit linear radon for surface-wave attenuation and 4D joint low-rank sparse inversion may enhance both diving and reflected waves. In southern Oman, where strong impedance contrasts create severe multiple contamination, a detailed near-surface velocity update using multi-wave inversion (MWI) with both active and passive (interferometry-derived) data may be combined with accurate reflection-based tomography to create a robust input model.

One may use a method to damp the energy of direct-arrival-looking events during acoustic modeling, as this energy might not be represented in the observed data, which can mislead the FWI update (Wang et al., 2021). More specifically, the authors in this paper addressed the issue of direct-arrival energy not being represented in the observed data, which may otherwise adversely affect the FWI update. One may use a method to attenuate these events' energy during acoustic modeling. One approach involves empirically scaling down the near-surface wavefield at each modeling time step before proceeding to the next. This procedure may reduce the dominance of strong energy from the shallow wavefield, thereby mitigating potential negative impacts on the FWI update.

Data preconditioning for acoustic FWI may not always prove optimal. Data components that an acoustic modeling engine cannot model create artifacts in the velocity update (see, Stopin et al., 2014). The authors in Stopin indicated that data components that cannot be modelled using an acoustic modelling engine create artifacts in the velocity update.

Elastic FWI then appears as a natural solution, as it allows better modelling the true physics of the seismic recorded data. However, the authors in Cheng et al. (2017) indicated that when applying elastic FWI or elastic reverse-time migration (RTM), ground roll is always modeled in the forward modeling, thus leading to an inconsistency between the pre-conditioned observed data and the modeled data.

A difference between acoustic FWI and the proposed elastic FWI is that acoustic FWI uses an acoustic wave equation, which is a simplified scalar equation, compared to a vector wave equation, which is a wavefield equation, used in elastic FWI. The inverted parameters in scalar FWI are mainly the P-wave velocity, and sometimes the density, but for elastic FWI, the S-wave velocity is also inverted, in addition to the P-wave velocity. Further, an acoustic FWI model considers only the reflection and transmission of P-waves while elastic FWI also accounts for P-to-S and S-to-P mode conversions, S-waves, and surface waves.

Thus, a need exists for a new method for reducing surface waves during modeling in elastic land FWI while maintaining a free-surface boundary condition.

### SUMMARY OF THE INVENTION

Embodiments for a system and method for inverting seismic data in elastic FWI are disclosed in this document. The system provides an improved velocity model of a subsurface by attenuating energetic interface waves during the modeling process, thereby allowing the FWI to focus on body waves, such as reflections, which may provide more information about deeper structures. By selectively attenuating interface waves in the model domain, the disclosed embodiments may reduce artifacts and/or instabilities in the velocity update process. The artifacts and/or instabilities may occur when a mismatch exists between pre-conditioned recorded data, where interface waves are removed, and modeled data, where interface waves are generated.

In one aspect, a method for inverting seismic data is provided. The method includes receiving recorded seismic data. The method calculates a wavefield for an attenuated interface wave based on an attenuation term that describes a wave attenuation along a travelling direction, at an interface between two different media. The method then calculates an updated velocity model using the wavefield corresponding to the attenuated interface wave and a body wave function. Finally, the method generates an image of the subsurface based on the updated velocity model.

In some embodiments, the attenuation term is added (1) to the calculated wavefield in a model domain or (2) to wave equations for calculating the wavefield. The interface wave may include an amplitude, a penetrating decay term, a phase term, and the attenuation term. The penetrating decay term is related to a spatial decay of the wave, along a penetrating depth direction substantially perpendicular to the interface, the phase term is related to a phase of the wave, and the attenuation term is related to a propagation path of the wave along the interface. One may apply this attenuation term within a specified region of the subsurface, such as a region where a maximum energy of the interface wave is entrapped.

The method may apply to various types of waves. For example, the body wave may be a P-wave or an S-wave, and the attenuated wave may be a guided wave, a Love wave, a Rayleigh wave, a Stoneley wave, or a Scholte wave. By selectively attenuating the interface waves, the method may enhance the visibility and contribution of body waves to the inversion process, leading to a more accurate and higher-resolution velocity model.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a seismic survey system illustrating a body wave and a surface wave.

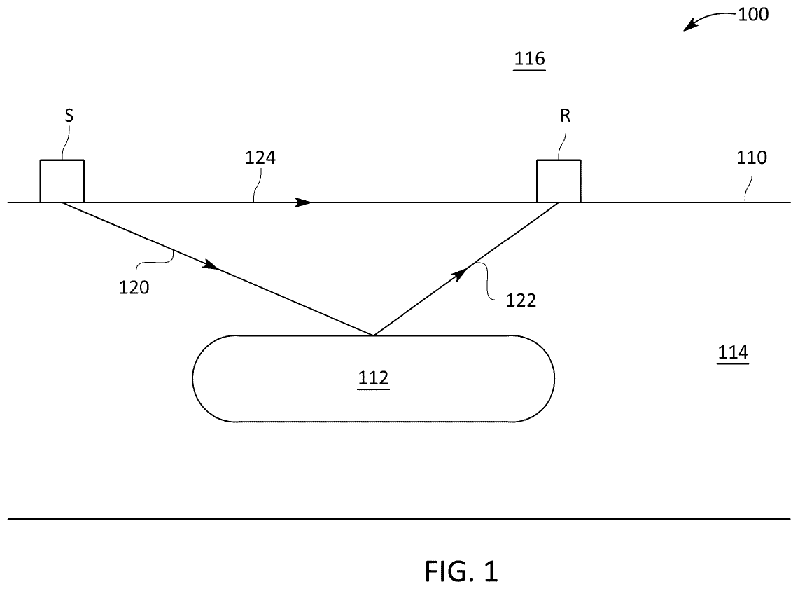

FIG. 2 is a flowchart illustrating a conventional FWI method.

FIG. 3 is a flowchart illustrating a method for FWI with attenuation of surface waves, according to an embodiment.

FIG. 4 schematically illustrates a surface wave and two damping directions for attenuating an energy of the surface wave.

FIG. 5A is a seismic shot gather illustrating modeled data without model based surface wave attenuation.

FIG. 5B is a seismic shot gather illustrating modeled data with model based surface wave attenuation, according to an embodiment.

FIG. 6 is a flow chart of a method for FWI that incorporates model based attenuation of surface waves to improve subsurface velocity model accuracy.

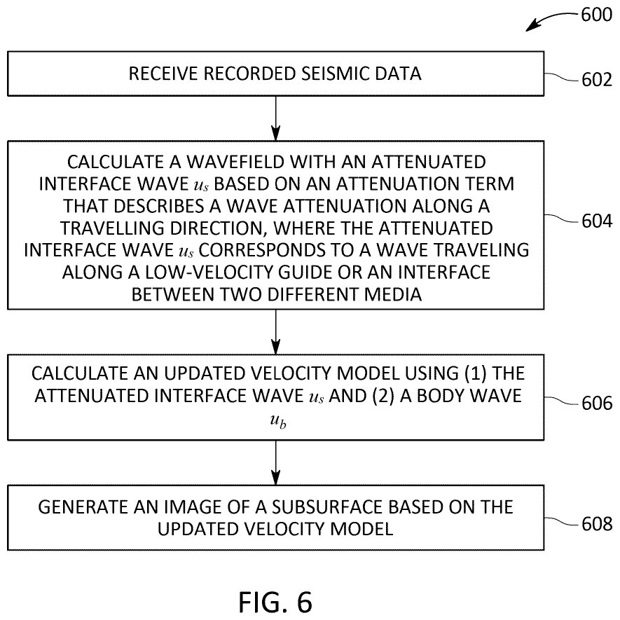

FIG. 7 is a schematic diagram of a computing system in which the methods discussed in this document may be implemented.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. For simplicity, the following embodiments discuss an elastic FWI method with a free-surface boundary condition that attenuates surface waves during modeling. However, the discussed embodiments also apply to other processes that involve interface and guided wave attenuation.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The methods discussed herein may apply to subsurface exploration fields, such as hydrocarbon exploration and development, geothermal exploration and development, and carbon capture and sequestration, or other natural resource exploration and exploitation. The methods may also be employed for surveying and monitoring for wind farm applications, both onshore and offshore.

Prior to discussing elastic FWI with surface wave attenuation, a traditional FWI method is discussed. As noted previously, land or marine seismic surveys may extract rock properties and construct reflectivity images of the subsurface. Such surveys may provide an accurate image of the surveyed subsurface Earth structure. The subsurface structure may be associated with mineral resources and/or hydrocarbon reservoirs. Thus, having high-quality tools for processing recorded seismic data to generate a high-accuracy image of the surveyed substructure is beneficial. Generating the subsurface image is a continuously improving technological process, and the following description continues this line of improvement.

FWI is one known method for analyzing seismic data. FWI may produce models in a subsurface region of physical properties, such as a P-wave velocity (Vp) model or a density model, that exhibit high fidelity and are spatially well-resolved. In one embodiment, FWI seeks to extract subsurface rock properties from a seismic dataset recorded at a surface or a seabed. The FWI technique iteratively updates a two- or three-dimensional velocity or density model to represent the surveyed subsurface Earth model, such that generated seismic data matches the recorded seismic data.

In this example, one uses a velocity model to calculate an estimate of the seismic dataset, also referred to as a predicted seismic dataset. The predicted seismic dataset is then compared to the recorded seismic dataset d. Based on a mismatch between the two datasets, one iteratively updates the velocity model until the predicted seismic dataset matches the recorded seismic data to a sufficient degree of accuracy or until a desired degree of convergence is obtained.

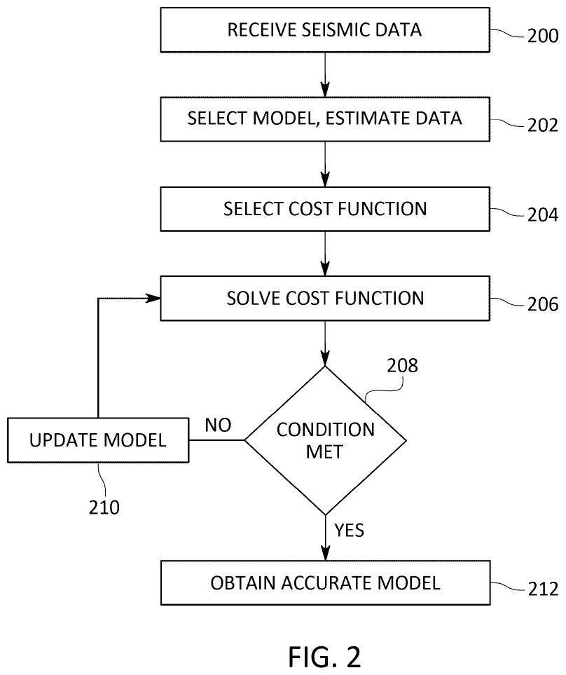

A general method of updating a velocity model with an FWI method is now described with regard to FIG. 2. The FWI may operate by iteratively updating a starting velocity model to minimize a cost function through repeated calculations. In step 200, a processor receives recorded seismic data d. The recorded seismic data may be recorded on land or in a marine environment and may be recorded with hydrophones, geophones, accelerometers, or any combination of these and other sensors. In step 202, the operator of the processor chooses a velocity model, for example, selected from an existing library or calculated based on existing data about a surveyed subsurface, and generates estimated seismic data based on the current velocity model. In step 204, the operator of the processor defines a cost function. The cost function may measure a mismatch or similarity between the recorded seismic data and the estimated seismic data. If the cost function represents the mismatch, it may compare traces from the two sets of data, for example, by subtracting one trace from the other.

Due to a non-linearity in the relationship between the velocity model and the seismic data, the cost function used in FWI may have many local minima rather than being a convex function with a single global minimum. Consequently, one may use a sufficiently accurate starting velocity model to achieve global minimum convergence. The cost function may be formulated in a frequency domain, a time domain, or any other suitable domain.

Localized gradient-based methods may be used in step 206 to minimize the cost function. These methods iteratively update the existing velocity model in a direction derived from the cost function's direction of steepest descent. After the processor calculates the cost function in step 206, it checks a predetermined condition in step 208. If the condition is not met, for example, a condition related to how closely the estimated data matches the recorded data, the process advances to step 210. In step 210, the FWI algorithm updates the starting velocity model and calculates a new data estimate. The process then returns to step 206 to recalculate and further minimize the cost function. This FWI process is a local iterative inversion scheme that makes a series of step-wise improvements to the model in step 210, successively reducing the cost function toward the predetermined condition. When the condition is met in step 208, the improved model is returned in step 212.

One may perform the step of minimizing the cost function according to various algorithms, e.g., conjugate gradient, Newton-type methods, global optimization methos, etc. The cost function may be formulated in various domains, as the frequency domain or the time domain.

Although elastic FWI may be a natural solution to investigate, as it allows for better modeling of the recorded seismic data's true physics, the method has its own limitations. Initial applications of elastic land FWI mainly focused on matching a diving-wave train using a mute to exclude ground-roll. For instance, Bharti et al. (2016) applied a 3D vertical transverse isotropic (VTI) elastic multi-parameter waveform inversion to a low-frequency, wide-aperture land dataset from North Kuwait to retrieve an accurate near-surface velocity profile. By focusing the inversion on diving compressional waves and accounting for elastic energy conversion, the process helped stabilize the inversion and better resolve formations at depths up to approximately one kilometer. A key part of that workflow involved dedicated data pre-processing to remove ground-roll and low-frequency noise. The multi-parameter elastic waveform inversion, carried out up to 6 Hz, resulted in improved focalization of certain geological formations.

Using such an approach, Leblanc et al. (2022) and Sedova et al. (2022) showed that an improved data fitting of elastic FWI, compared with acoustic FWI, may allow for an increased velocity model resolution. Moreover, when applying full-wavefield based imaging or inversion algorithms, ground roll is consistently modeled in forward modeling, which leads to an inconsistency between observed data and modeled data if the observed data has been pre-processed to remove it.

To further increase the resolution of an inverted velocity model with elastic FWI at high frequencies, it may be beneficial to include reflections in the inversion process, as performed for marine data. However, in the presence of a complex near-surface with fast S-wave velocities, as is common in the Middle East region, surface waves may be very energetic and overshadow a large part of much weaker reflected waves. Plessix and Pérez Solano (2015) proposed using a modified surface boundary condition that does not generate ground-roll during modeling. This condition decouples the P and S waves at the surface and provides a PP-reflection coefficient similar to an acoustic one. Although this method has been used in several elastic land FWI applications, a lack of P-to-S conversion at the surface may affect it, which results in a significant modification of amplitudes and phases of the data at far offsets, potentially compromising the results.

Another possibility involves inverting a whole dataset, including diving waves, reflections, and surface waves, using a more realistic free-surface condition, as proposed by He et al. (2019) and Adwani et al. (2022). He et al. proposed a land seismic multi-parameter FWI in elastic VTI media that simultaneously interprets both body waves and surface waves. They used an optimal transport (OT) objective function, coupled with a Gaussian time-windowing strategy, to balance contributions of different wave types. This approach may overcome an issue where high-energy surface waves mask weaker body waves, which may cause a gradient of a misfit function to have high values at shallow depths, preventing the recovery of deeper model parameters. The OT function focuses more on phase shifts and balances amplitudes of various arrivals, making an amplitude distribution of an OT adjoint source more uniform compared to a least-squares function. This may reduce the impact of high-amplitude surface waves on the misfit function and gradient calculation. Adwani et al. (2022) also proposed inverting an entire dataset using a conventional free-surface boundary condition while applying a weighting mask to mitigate an amplitude of the surface waves relative to body waves.

However, high-energy surface waves may dominate an FWI process while providing limited information about deep structures, which may necessitate a careful balancing of the amplitudes of various data components entering the inversion.

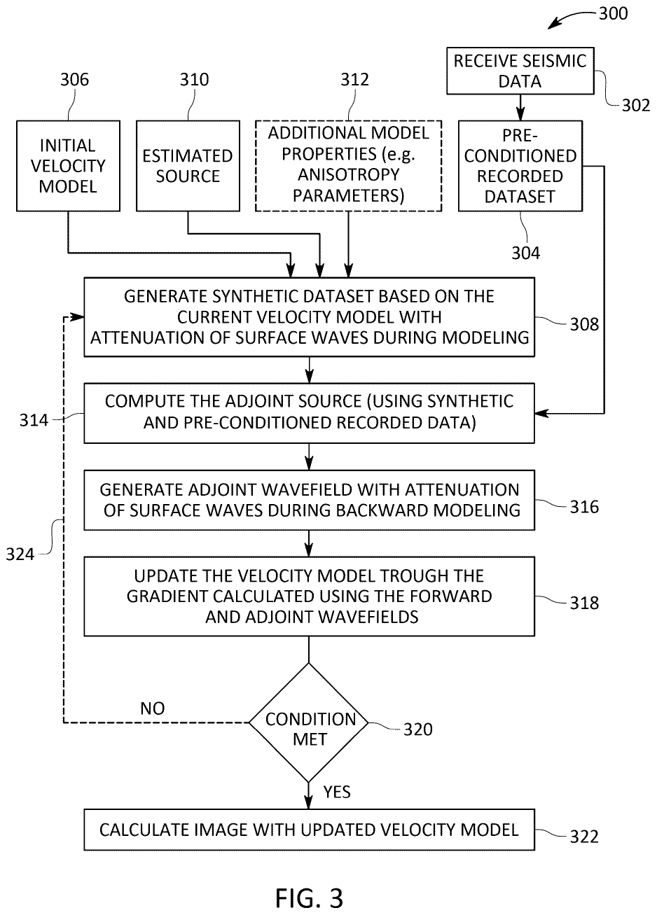

A proposed new method 300, which is illustrated in FIG. 3, for reducing surface waves during elastic FWI minimizes the effects of energy from the surface waves on the results. The method 300 starts with step 302, where a processor receives the recorded seismic data d. This step 302 is similar to step 200 of FIG. 2. The recorded seismic data may be recorded on land or in a marine environment and may be recorded with hydrophones, geophones, accelerometers, or any combination of these and other sensors. The recorded seismic data may include body waves (e.g., waves 122) and surface waves (e.g., waves 124). In step 304, the processor pre-conditions the recorded seismic data d to attenuate the surface waves. Any known method may be used for this step. In step 306, the processor chooses a velocity model, for example, selected from an existing library or calculated based on existing data about the surveyed subsurface.

In step 308, the processor generates estimated or synthetic seismic data based on the current velocity model. During this step, the processor also calculates forward wavefields. The processor calculates forward propagated wavefields with attenuation of surface waves during modeling within the desired depth and extracts the synthetic dataset at the receiver positions. The forward wavefields in elastic FWI are generated by numerically solving a chosen seismic wave equation, e.g., an elastic wave equation, and also using an estimated subsurface model and/or a source signature, which is discussed later.

The processor calculates 308 the forward wavefields, and similarly adjoint wavefields (discussed below), based on a modified wave equation as now discussed. The result of step 308 may be a full wavefield snapshot for every moment in time, showing propagation, reflection, diffraction of waves, and/or multiples (both surface related and interbed) through the synthetic subsurface model. The modeling may be performed using a free-surface boundary condition, or an absorbing boundary condition, in which case the surface wave may be generated in the presence of interfaces between rapidly varying velocity layers. The modeling may also generate guided waves in presence of a low-velocity guide (low-velocity layer between two faster-velocity layers) in the model. The modified wavefield relies on an attenuation or damping term in the wave equation. The processor applies the damping within a specified region of the subsurface, e.g., where the maximum energy of the interface or guided waves is entrapped, and not in the whole model. This is a model domain attenuation.

Considering that the surface (interface) waves travel consistently along specific horizons, such as the topography or the water bottom (other layer interfaces also possible), one may introduce special damping layers around these horizons to attenuate only the surface waves while preserving other wave types crossing the damping layers. Similarly, for guided waves, one may introduce special damping layers along the guide location to attenuate only the guided waves while preserving other wave types crossing the damping layers.

For conventional propagating waves, such as body waves in terms of longitudinal P- and transverse S-waves, one may express their wavefield u_{b} in a frequency domain as Equation (1):

$${u}_{b} ( x , y , z , ω ) = A ( x , y , z ) exp [ i ( {k}_{x} x + {k}_{y} y + {k}_{z} z ) ] , \qquad ( 1 )$$

where vector A(x, y, z) is an amplitude factor which may relate to a wave path and polarization, ω is an angular frequency, i is an imaginary unit, and kⱼ, j=x, y, z is a wavenumber in x-, y- and z-directions, respectively. In this example,

$$\vert k \vert = \frac{ω}{v}$$

and v IS a wave propagation velocity.

This wave representation may not apply to interface, guided or surface waves, such as Rayleigh waves (also known as ground roll), Love waves, Scholte waves, and Stoneley waves. These waves (i.e., interface or guided waves) may propagate parallel to an interface between different media and are exponentially damped in a direction perpendicular to the interface. As an example, a surface wave propagating in an x-y plane has a corresponding wave function uₛ in the frequency domain as shown in equation (2):

$${u}_{s} ( x , y , z , ω ) = A ( x , y ) exp ( - b z ) exp [ i ( {k}_{x} x + {k}_{y} y ) ] , \qquad ( 2 )$$

where b is a decay factor given by medium properties and determines a penetrating depth (from the propagating interface) of the interface wave. From the wave functions above, a wavefront of the surface wave is cylindrical, rather than spherical as in the body wave, and thus its wave energy declines slower with a geometric spreading. For this reason, ground roll may be the most energetic wave in land seismic datasets. One may desire to remove it during modeling so that elastic FWI may utilize more of the body waves.

A proposed approach for model based attenuating surface waves, i.e., at each iteration of the method 300, during wave-propagation modeling of elastic waves, introduces an artificial damping along propagation directions of surface waves uₛ, which causes the surface wave energy to fall off gradually along its wave path, from a source. For a 2D wave-propagation of a surface wave uₛ, propagating in an x-direction but exponentially damped in a z-direction, one may write a harmonic plane-wave solution as:

$${u}_{s} ( x , z , ω ) = A exp ( - b z ) exp [ i ( {k}_{x} x ) ] . \qquad ( 3 )$$

To achieve the model based attenuation of the surface wave uₛ along the propagation path, one introduces an attenuation term into the wave equations, and one may rewrite an original wave function as follows:

$${u}_{s} ( x , z , ω ) = A exp ( - b z ) exp ( - \frac{d {k}_{x}}{ω} {\int }_{0}^{x} ds ) exp [ i ( {k}_{x} x ) ] , \qquad ( 4 )$$

where uₛ (x, z, ω) is the attenuated interface wave wavefield, d is a tunable damping factor to control an attenuation intensity and

$${\int }_{0}^{x}$$

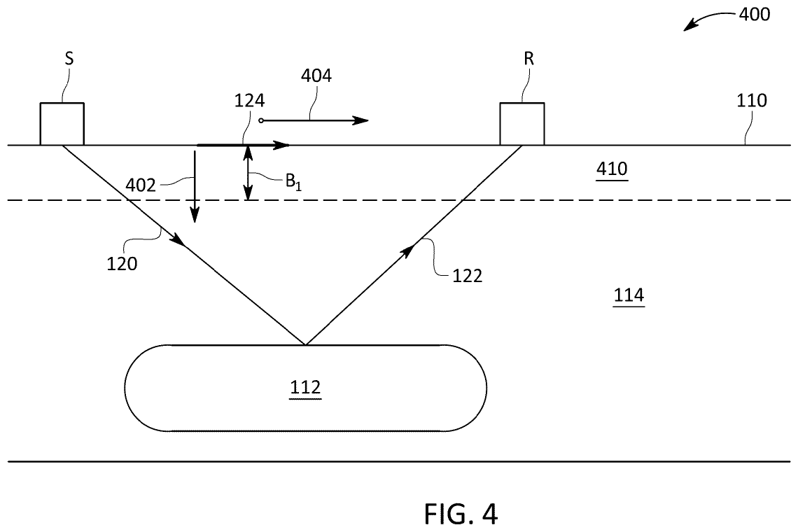

as is a pain integral along the propagating direction of the surface wave (the x-direction in this case). FIG. 4 schematically illustrates the propagation direction 404 along which the term

$${\int }_{0}^{x} d s$$

acts. FIG. 4 also shows the penetrating direction 402 of the surface wave. In one embodiment, a maximum penetrating distance B1 may be considered for the surface waves, i.e., any surface wave is considered during the modelling to experience attenuation within the region defined by B1, along the penetrating direction 402. This attenuation term along the propagation direction 404 effectively modifies the amplitude of the surface wave as it propagates, ensuring that its energy decays not only due to exponential damping in the perpendicular direction, but also along the propagation path itself. By incorporating this approach, one can control the dominance of the surface waves in the wavefield, enhancing the clarity of body wave signals for further analysis.

By defining a complex propagating direction \tilde{x} as:

$$\tilde{x} ( x ) = x + \frac{i d}{ω} {\int }_{0}^{x} d s , \qquad ( 5 )$$

the plane-wave function in equation (4) becomes:

$${u}_{s} ( x , z , ω ) = A exp ( - b z ) exp [ i ( {k}_{x} \tilde{x} ) ] . \qquad ( 6 )$$

Note that the equations used for exemplifying the method 300 use, for simplicity, a plane-wave function. However, one skilled in the art would understand that the surface wave is not limited to a plane wave, but all types of interface waves may be considered for the surface wave.

Based on equation (6), an embodiment equivalent to the one described by equation (4) can be achieved by extending/stretching the propagation direction vector of the surface waves, from a real value to a complex value within the penetration depth. In this manner, the original elastodynamics equation, shown as equation (7), is obtained:

$$ρ {\partial }_{tt} u = {∇}_{( x , y , z )} \cdot σ , σ = C : {∇}_{( x , y , z )} u , \qquad ( 7 )$$

where ρ is a density of the medium, σ is a second-order stress tensor, and C is a fourth-order elasticity tensor. One may rewrite equation (7) by substituting the coordinates along surface wave propagating planes, for example, an x-y plane in a Cartesian coordinate system, with complex coordinates as shown in Equation (8):

$$ρ {\partial }_{tt} u = {∇}_{( \tilde{x} , \tilde{y} , z )} \cdot σ , σ = C : {∇}_{( \tilde{x} , \tilde{y} , z )} u , \qquad ( 8 )$$

where a relationship between ∇_{(x,y,z)} and ∇_{(\tilde{x},\tilde{y},z)} is given by:

$${∇}_{\tilde{x}} = \frac{1}{D} {∇}_{x} , {∇}_{\tilde{y}} = \frac{1}{D} {∇}_{y} , {∇}_{\tilde{z}} = {∇}_{z} , \qquad ( 9 )$$

with

$$D = 1 + \frac{i d}{ω} .$$

This is similar to a damping function applied in Perfectly Matching Layer (PML) conditions, as discussed in Festa and Nielsen (2003), for absorbing artificial reflections at edges of a wave modeling area.

For this method, one applies the damping within a specified region (e.g., cylindrical region having a radius B1, around axis 404 in FIG. 4) where a maximum energy of the surface or guided waves is entrapped, not in a whole model (whole space corresponding to the subsurface 114). Considering that surface waves travel consistently along specific horizons (e.g., along direction 404), one may introduce damping layers (only one layer 410 shown in FIG. 4, but more are possible) around these horizons to attenuate them specifically while preserving other waves crossing the damping layers. In this way, one may dynamically attenuate the energy of surface waves uₛ during elastic wave modeling. As examples, specific expressions are later listed of a 2D isotropic elastic wave-equation with a stress-velocity formulation, as described in Virieux (1986) using both a Cartesian coordinate system and a curvilinear one to allow damping of surface waves along an irregular topography.

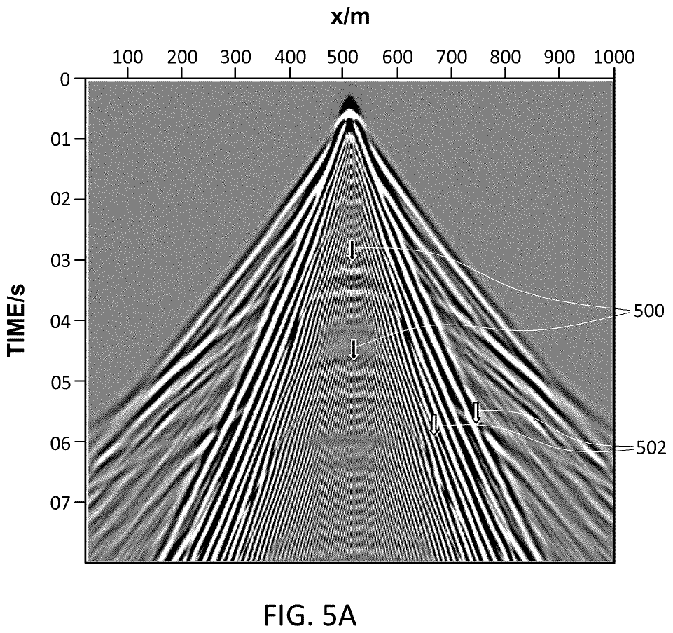

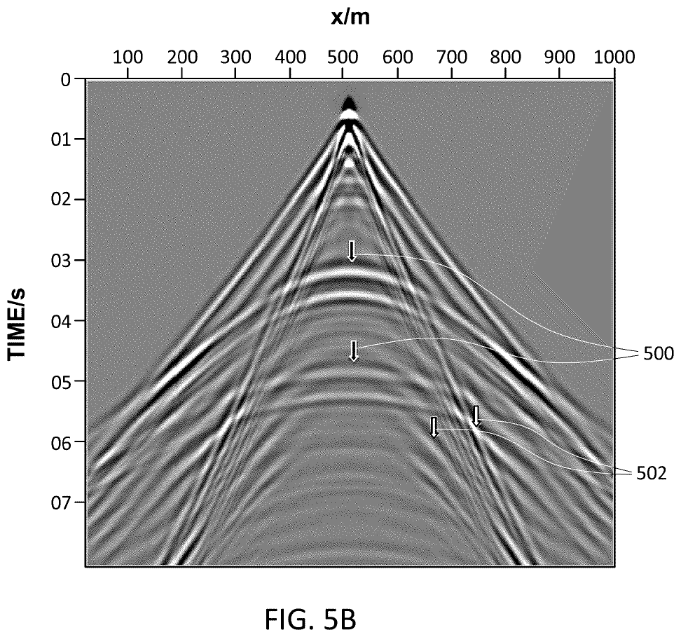

FIG. 5A shows an example of elastic modeled data without model based surface wave attenuation during modeling, i.e., elastic modeled data with free-surface boundary condition which creates very energetic surface waves. FIG. 5B shows an example of elastic modeled data with model based surface wave attenuation during modeling, according to the method of FIG. 3. The figures show time, in seconds, on the Y axis and the location of the receivers, in meters, on the X axis. One may note that PP reflections 500 are more visible at near offsets, and S-related reflections 502 are uncovered below a surface-wave train.

Returning to FIG. 3, in step 310, the processor injects a digital representation of a seismic source (e.g., a source wavelet) into a model grid at a precise location of the source in a field survey. Optionally, the method 300 may receive 312 additional model properties, e.g., anisotropy parameters of the subsurface. Next, the processor computes 314 an adjoint source, according to a desired cost function, based on the current velocity model with compressional and shear-wave velocities, the pre-conditioned measured data, which is a recorded dataset d, and, optionally, extra models for an elastic modeling engine, such as anisotropy, density, and so on obtained in step 312. The adjoint source may represent a difference between actual recorded seismic data and synthetic data computed from the current subsurface model.

In step 316, the method generates an adjoint wavefield based on the computed adjoint source, with attenuation of surface waves during backward modeling. More specifically, one injects the adjoint source back into the model at receiver locations and propagates it backward in time using the same modified wave equation as in the forward propagation. This creates the adjoint wavefield. In step 318, the processor updates the velocity model through a gradient method calculated using the forward and adjoint wavefields. The gradient method may calculate a direction and magnitude of a model update by cross correlating the forward wavefield with the adjoint wavefield over an entire model domain.

In step 320, the processor determines whether a sufficient number of iterations have been performed, or in other words, whether a predetermined condition or criterion has been met. If a sufficient number of iterations have been performed or the criterion has been met, the method advances to step 322 and calculates an image of the subsurface based on updated parameters for the velocity model. If the number of iterations has not yet been satisfied or the criterion has not yet been met, the method returns 324 to step 308 and iteratively performs the steps for the number of iterations or until the predetermined condition is met.

The method 300 has been presented here for a 2D case, but it may be extended for 3D modeling problems including anisotropy, viscosity, and fluid-solid coupling, within frameworks of different wave-equation formulation variants. Moreover, this method is not limited to an attenuation of surface waves in a land dataset, but it may be adapted to attenuate any type of wave traveling along an interface, such as Rayleigh waves, Love waves, Scholte waves, Stoneley waves, Lamb waves, and more generally any type of guided wave. This method is not only valid for flat interfaces and horizons but for any horizon/interface shape. It may also be extended to attenuation of any type of wave energy, such as sound waves, thermal waves, and any other type of radiative energy traveling through an interface, not necessarily due to propagation in material media.

The proposed method is a model-based approach for attenuating surface waves. Similarly to data domain approaches, it may selectively attenuate surface waves and substantially preserve body-wave reflections, multiples and mode conversions. This allows for choosing the type of wave to attenuate by selecting the application area. However, attenuating the surface waves in the model domain may also prevent the energetic wave from traveling in the shallow part of the model. When cross-correlating forward and backward wavefields, this may avoid creating spurious updates of the model.

The specific expressions of the 2D isotropic elastic wave-equation with the stress-velocity formulation for damping the surface waves in method 300 are as follows. The wave-equation in Cartesian system can be written as:

$$( {\partial }_{t} - d ) ρ {v}_{1}^{x} = {\partial }_{x} {σ}^{x x} , {\partial }_{t} ρ {v}_{2}^{x} = {\partial }_{z} {σ}^{x z} , \qquad ( 10 )$$

$$( {\partial }_{t} - d ) ρ {v}_{1}^{z} = {\partial }_{x} {σ}^{xz} , {\partial }_{t} ρ {v}_{2}^{z} = {\partial }_{z} {σ}^{zz} ;$$

$$( {\partial }_{t} - d ) {σ}_{1}^{x x} = {C}_{11} {\partial }_{x} {v}^{x} , {\partial }_{t} {σ}_{2}^{x x} = {C}_{13} {\partial }_{z} {v}^{z} ,$$

$$( {\partial }_{t} - d ) {σ}_{1}^{x z} = {C}_{55} {\partial }_{x} {v}^{z} , {\partial }_{t} {σ}_{2}^{x z} = {C}_{55} {\partial }_{Z} {v}^{x} ,$$

$$( {\partial }_{t} - d ) {σ}_{1}^{zz} = {C}_{13} {\partial }_{x} {v}^{x} , {\partial }_{t} {σ}_{2}^{zz} = {C}_{33} {\partial }_{z} {v}^{z} ,$$

where the velocity wavefield x- and z-components are

$${v}^{x} = {v}_{1}^{x} + {v}_{2}^{x} and {v}^{z} = {v}_{1}^{z} + {v}_{2}^{z}$$

respectively, the stress components are

$${σ}^{x x} = {σ}_{1}^{x x} + {σ}_{2}^{x x} , {σ}^{x z} = {σ}_{1}^{x z} + {σ}_{2}^{x z} and$$

$${σ}^{zz} = {σ}_{1}^{zz} + {σ}_{2}^{zz} ,$$

d is the tunable damping factor to control the attenuation intensity mentioned above, Cᵢⱼ is the elasticity tensor component of VTI (vertical transverse isotropy) medium following Voigt notation, and p is the density of the medium.

The same equations may be expressed in curvilinear coordinates (q, s) as:

$$( {\partial }_{t} - d ) ρ {v}_{1}^{x} = ( {\partial }_{q} + {s}_{x} {\partial }_{s} ) {σ}^{x x} , {\partial }_{t} ρ {v}_{2}^{x} = {s}_{z} {\partial }_{s} {σ}^{x z} , \qquad ( 11 )$$

$$( {\partial }_{t} - d ) ρ {v}_{1}^{z} = ( {\partial }_{q} + {s}_{x} {\partial }_{s} ) {σ}^{x z} , {\partial }_{t} ρ {v}_{2}^{z} = {s}_{z} {\partial }_{s} {σ}^{zz} ;$$

$$( {\partial }_{t} - d ) {σ}_{1}^{x x} = {C}_{11} ( {\partial }_{q} + {s}_{x} {\partial }_{s} ) {v}^{x} , {\partial }_{t} {σ}_{2}^{x x} = {C}_{13} {s}_{z} {\partial }_{s} {v}^{z} ,$$

$$( {\partial }_{t} - d ) {σ}_{1}^{x z} = {C}_{55} ( {\partial }_{q} + {s}_{x} {\partial }_{s} ) {v}^{z} , {\partial }_{t} {σ}_{2}^{x z} = {C}_{55} {s}_{z} {\partial }_{s} {v}^{x} ,$$

$$( {\partial }_{t} - d ) {σ}_{1}^{zz} = {C}_{13} ( {\partial }_{q} + {s}_{x} {\partial }_{s} ) {v}^{x} , {\partial }_{t} {σ}_{2}^{zz} = {C}_{33} {s}_{z} {\partial }_{s} {v}^{z} ,$$

where the velocity wavefield x- and z-components

$${v}^{x} = {v}_{1}^{x} + {v}_{2}^{x} and {v}^{z} = {v}_{1}^{z} + {v}_{2}^{z} ,$$

respectively, the stress components

$${σ}^{xx} = {σ}_{1}^{xx} + {σ}_{2}^{xx} , {σ}^{xz} = {σ}_{1}^{xz} + {σ}_{2}^{xz} and {σ}^{zz} = {σ}_{1}^{zz} + {σ}_{2}^{zz} ,$$

d is the tunable damping factor to control the attenuation intensity mentioned before, Cᵢⱼ is elasticity tensor component of VTI (vertical transverse isotropy) medium following Voigt notation, ρ is the density of the medium, and sₓ and s_{z} are metric derivatives describing the mapping between curvilinear system and Cartesian system.

In some embodiments, compared to other model-based attenuation methods, the disclosed approach may not introduce spurious waves or substantially change the phase or amplitude of reflected or converted body waves.

One or more of the embodiments discussed above may be implemented as a method 600 for inverting seismic data in an elastic FWI. The method includes a step 602 of receiving recorded seismic data, a step 604 of calculating a wavefield with an attenuated interface wave uₛ based on an attenuation term that describes a wave attenuation along a travelling direction, where the attenuated interface wave uₛ corresponds to a wave traveling along a low-velocity guide or along an interface between two different media and the travelling direction is aligned with the interface. Note that the wavefield is calculated based on the waves present at each point in the field. In this regard, a wave is the phenomenon of a disturbance propagating through a medium or space, transferring energy without permanently transferring matter while a wavefield is the extended area or space that the wave occupies, defined by the physical property (like pressure, displacement, or electric field strength) it measures at all points within that area and at all times of interest.

The method further includes a step 606 of calculating an updated velocity model using (1) the wavefield corresponding to the attenuated interface wave uₛ and (2) a body wave wavefield u_{b}; and a step 608 of generating an image of a subsurface based on the updated velocity (or other parameters, such as density, viscosity, compressional or shear-velocity, anisotropy) model. In one embodiment, the updated velocity model is obtained by computing a gradient of (1) the forward modeling with the modified wave-equation (with the surface wave attenuation) and (2) the backward modeling with the modified wave-equation (with the surface wave attenuation). The attenuation term is either added to the calculated wavefield in a model domain (see equation (4) above) or to the wave equations (see equation (9), for calculating the wavefield.

The interface wave wavefield has an amplitude, a penetration decay (evanescent) term, a phase term, and the attenuation term. The penetration decay term is related to a spatial decay of the interface wave, along a penetrating depth direction substantially perpendicular to the interface, the phase term is related to a phase of the wave, and the attenuation term is related to a propagation path of the surface wave along the interface. As noted above, the attenuation term can also be applied as a supplementary term to the modeled wavefields afterwards and not during the modeling itself.

In one embodiment, the path integral is multiplied by a ratio between (1) a product between a tunable damping factor and the wavenumber, and (2) an angular frequency to obtain the attenuation term. The attenuation term is applied within a specified depth around the interface in the subsurface. The specified depth is where the maximum energy of the surface wave is entrapped. The body wave function describes one of a longitudinal wave, a transverse wave, a P-wave, or an S-wave, and the surface wave wavefield describes one of a guided wave, interface wave, a ground-roll wave, rolling wave, a Love wave, a Rayleigh wave, a Stoneley wave, or a Scholte wave or a guided wave.

The method may further include pre-conditioning the recorded seismic data by suppressing the surface wave prior to using the recorded data to compute the adjoint source. The step of calculating may include computing forward propagated wavefields with attenuation of surface waves within a desired depth, based on a source function, computing an adjoint source according to a cost function, backward propagating the adjoint source to calculate backward propagated wavefields with attenuation of surface waves within the desired depth, and updating an initial velocity model to obtain the updated velocity model using a gradient obtained through a cross-correlation between the forward propagated wavefields and the backward propagated wavefields.

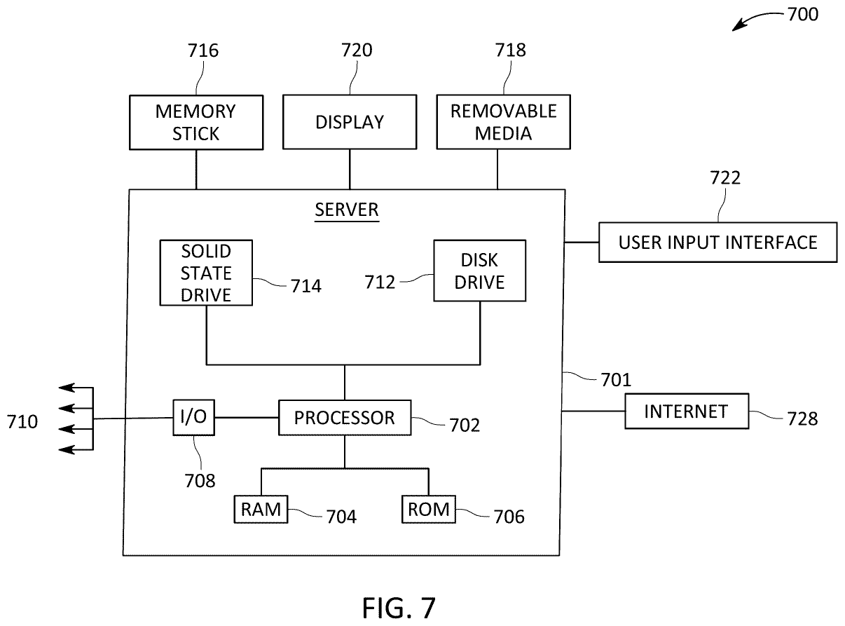

One may implement the above-discussed procedures and methods in a computing device as illustrated in FIG. 7. Hardware, firmware, software, or a combination thereof may perform the various steps and operations described herein. The computing device 700 is suitable for performing the activities described in the above embodiments and may include a server 701. Such a server 701 may include a central processor (CPU) 702 coupled to a random access memory (RAM) 704 and to a read-only memory (ROM) 706. ROM 706 may also be other types of storage media to store programs, such as programmable ROM (PROM), erasable PROM (EPROM), etc. Processor 702 may communicate with other internal and external components through input/output (I/O) circuitry 708 and bussing 710 to provide control signals and the like. Processor 702 carries out a variety of functions as known in the art, as dictated by software and/or firmware instructions.

Server 701 may also include one or more data storage devices, including hard drives 712, solid-state drives 714, and other hardware capable of reading and/or storing information, such as DVD, etc. In one embodiment, software for carrying out the above-discussed steps may be stored and distributed on a memory stick 716, a solid-state storage device 718, or other form of media capable of portably storing information. These storage media may be inserted into, and read by, devices such as solid-state drive 714, disk drive 712, etc. Server 701 may be coupled to a display 720, which may be any type of known display or presentation screen, such as LCD, plasma display, cathode ray tube (CRT), etc. A user input interface 722 is provided, including one or more user interface mechanisms such as a mouse, keyboard, microphone, touchpad, touch screen, voice-recognition system, etc.

Server 701 may be coupled to other devices, such as a seismic source, a receiver, etc. The server may be part of a larger network configuration as in a global area network (GAN) such as the Internet 728, which allows ultimate connection to various landline and/or mobile computing devices.

As described above, a computing device may embody the apparatus 700. However, in some embodiments, a chip or chip set may embody the apparatus. In other words, the apparatus may comprise one or more physical packages, e.g., chips, including materials, components, and/or wires on a structural assembly, e.g., a baseboard. The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chip set may constitute means for performing one or more operations for providing the functionalities described herein.

The processor 702 may be embodied in a number of different ways. For example, the processor may be embodied as one or more of various hardware processing means such as a coprocessor, a microprocessor, a controller, a digital signal processor (DSP), a processing element with or without an accompanying DSP, a graphics processing unit (GPU), or various other processing circuitry including integrated circuits such as, for example, an ASIC (application-specific integrated circuit), an FPGA (field-programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally, or alternatively, the processor may include one or more processors configured in tandem via the bus to enable independent execution of instructions, pipelining, and/or multithreading.

In an example embodiment, the processor 702 may be configured to execute instructions stored in the memory device 704 or otherwise accessible to the processor. Alternatively, or additionally, the processor may be configured to execute hard-coded functionality. As such, whether configured by hardware or software methods, or by a combination thereof, the processor may represent an entity, e.g., physically embodied in circuitry, capable of performing operations according to an embodiment while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when one executes the instructions. However, in some cases, the processor may be a processor of a specific device, e.g., a pass-through display or a mobile terminal, configured to employ an embodiment by further configuration of the processor by instructions for performing the algorithms and/or operations described herein. The processor may include, among other things, a clock, an arithmetic logic unit (ALU), and logic gates configured to support operation of the processor.

Certain examples are described in this disclosure as including logic or a number of components or modules. Modules may be software modules, e.g., code or machine-readable instructions stored on a non-transitory machine-readable medium, or hardware modules. A hardware module is a tangible unit capable of performing certain operations and may be configured or arranged in a certain manner. A hardware module may comprise dedicated circuitry or logic that is permanently configured, e.g., as a special-purpose processor, such as a field-programmable gate array (FPGA), an application-specific integrated circuit (ASIC), or a digital signal processor (DSP), to perform certain operations. A hardware module may also comprise programmable logic or circuitry, e.g., as encompassed within a general-purpose processor or other programmable processor, that is temporarily configured by software to perform certain operations. Cost and time considerations may drive the decision to implement a hardware module in dedicated and permanently configured circuitry, or in temporary configured circuitry, e.g., configured by software.

When implemented in software, the techniques may be provided as part of an operating system, a library used by multiple applications, or a particular software application. One or more general-purpose processors or one or more special-purpose processors may execute the software.

Upon reading this disclosure, those of skill in the art will appreciate still additional and alternative structural and functional designs for handling mobility between base stations through the principles disclosed herein. Thus, while particular examples and applications have been illustrated and described, one is to understand that the disclosed examples are not limited to the precise construction and components disclosed herein. Various modifications, changes, and variations, which will be apparent to those of ordinary skill in the art, may be made in the arrangement, operation, and details of the method and apparatus disclosed herein without departing from the spirit and scope defined in the appended claims.

Numerical adjectives “first”, “second”, and “third” do not imply any order, they are not ordinals, but are markers to distinguish separate instances of similar elements. References to the singular, e.g., “a” or “an”, “the”, should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. One may implement the methods or flowcharts in a computer program, software, or firmware tangibly embodied in a computer-readable storage medium for execution by a specifically programmed computer or processor.

The terms “about” and “substantially” when used in this application mean a variation of up to 20% of the parameter characterized by these terms.

The disclosed embodiments provide a method that focuses on processing body waves while applying a model-based attenuation of surface waves during elastic wave modeling, for example, by applying artificial damping and complex coordinate transformations. This technique enables the inversion process to focus on body waves, improving model resolution, and can be extended to various interface-guided waves and modeling scenarios. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The entire content of all the publications listed herein is incorporated by reference in this patent application.
Adwani, A., Danilouchkine, M., Al-Siyabi, Q., Al-Droushi, O., Ten Kroode, F., Plessix, R. and Ernst, F. [2022] Onshore model building using elastic full-waveform inversion on surface and body waves: A case study from Sultanate of Oman. Geophysics, 87 (6), R413-R424.
Bharti, S., Stopin, A., Solano, C. A. P., Plessix, R.-E., Lutz, J., Al-Qadeeri, B., Dashti, Q., Narhari, S. and Kolawole, O. O. [2016] Application of an anisotropic elastic multiparameter waveform inversion on a land data set from north Kuwait. 86^{th} SEG Annual International Meeting, Expanded Abstracts, 1201-1205.
Cheng, X., Jiao, K., Sun, D., Xu, Z., Vigh, D. and El-Emam, A. [2017] High-resolution Radon preconditioning for full-waveform inversion of land data. Interpretation, 5 (4), SR23—SR33.
Festa, G. and Nielsen, S. [2003] PML absorbing boundaries, Bulletin of the Seismological Society of America, 93 (2), 891-903.
Guo, Y. and Aziz, A. [2024] New geological understanding with land FWI Imaging, a Sultanate of Oman case study. 85^{th} EAGE Conference and Exhibition, Extended Abstracts.
He, W., Brossier, R., Métivier, L., and Plessix, R. E. [2019]. Land Seismic Multi-Parameter FWI in Elastic VTI Media by Simultaneously Interpreting Body Waves and Surface Waves, Expanded Abstracts, 81st EAGE Conference & Exhibition, Extended Abstracts, Tu_R08_09.
Leblanc, O., Sedova, A., Lambaré, G., Allemand, T., Hermant, O., Carotti, D., Donno, D. and Masmoudi, N. [2022] Elastic Land Full-Waveform Inversion in The Middle East: Method and Applications. 83rd EAGE Conference & Exhibition, Extended Abstracts.
Pérez Solano, C. A., Plessix, R.-E. [2019] Velocity-model building with enhanced shallow resolution using elastic waveform inversion—An example from onshore Oman. Geophysics, 84 (6), R977-R988.
Plessix, R.-E., Pérez Solano, C. A. [2015] Modified surface boundary conditions for elastic waveform inversion of low-frequency wide-angle active land seismic data. Geophysical Journal International, 201 (3), 1324-1334.
Sedova, A., Leblanc, O., Allemand, T., Lambaré, G., Pellerin, S. and Donno, D. Elastic FWI application to a land data set in the Middle East. 2^{nd} International Meeting for Applied Geoscience & Energy (IMAGE), SEG, Expanded Abstracts, 2389-2393.
Štekl, I., and R. Gerhard Pratt. “Accurate viscoelastic modeling by frequency-domain finite differences using rotated operators.” Geophysics 63, no. 5 (1998): 1779-1794.
Stopin, A., Plessix, R.-E., Al Abri, S. [2014] Multiparameter waveform inversion of a large wide azimuth low-frequency land data set in Oman. Geophysics, 79 (3), WA67-WA77.
Virieux, J. [1986] P-SV wave propagation in heterogeneous media: Velocity-stress finite-difference method. Geophysics, 51 (4), 889-901.
Wang, D., Chen, C., Zhuang, D., Mei, J. and Wang, P. [2021] Land FWI: challenges and possibilities. 82^{nd} EAGE Conference & Exhibition, Extended Abstracts.

What is claimed is:

1. A method for inverting seismic data in elastic full waveform inversion (FWI), the method comprising:
receiving recorded seismic data;
calculating a wavefield with an attenuated interface wave uₛ based on an attenuation term that describes a wave attenuation along a travelling direction, wherein the attenuated interface wave uₛ corresponds to a wave traveling along a low-velocity guide or along an interface between two different media and the travelling direction is aligned with the interface;
calculating an updated velocity model using (1) the wavefield corresponding to the attenuated interface wave uₛ and (2) a body wave wavefield u_{b}; and
generating an image of a subsurface based on the updated velocity model of the subsurface.

2. The method of claim 1, wherein the attenuation term is added (1) to the calculated wavefield in a model domain or (2) to wave equations for calculating the wavefield.

3. The method of claim 2, wherein the attenuated interface wave has an amplitude, a penetrating decay term, a phase term, and the attenuation term.

4. The method of claim 3, wherein the penetrating decay term is related to a spatial decay of the wave, along a penetrating depth direction substantially perpendicular to the interface, the phase term is related to a phase of the wave, and the attenuation term is related to a propagation path of the wave along the interface.

5. The method of claim 1, wherein the attenuation term is applied within a specified depth around the interface in the subsurface.

6. The method of claim 5, wherein the specified depth is where a maximum energy of the interface wave is entrapped.

7. The method of claim 1, wherein the body wave function describes one of a longitudinal wave, a transverse wave, a P-wave, or an S-wave, and the attenuated interface wave describes one of a surface wave, a ground-roll wave, a Love wave, a Rayleigh wave, a Stoneley wave, or a Scholte wave or a guided wave.

8. The method of claim 1, further comprising:
pre-conditioning the recorded seismic data by suppressing an interface wave.

9. The method of claim 1, wherein the calculating comprises:
computing forward propagated wavefields with attenuation of first specific waves within a desired depth, based on a source function;
computing an adjoint source according to a cost function;
backward propagating the adjoint source to calculate backward propagated wavefields with attenuation of second specific waves within the desired depth; and
updating an initial velocity model to obtain the updated velocity model using a gradient obtained through a cross-correlation between the forward propagated wavefields and the backward propagated wavefields.

10. A computing system for inverting seismic data in seismic full waveform inversion (FWI), comprising:
a memory configured to store recorded seismic data and an initial subsurface velocity model;
a processor coupled to the memory, the processor configured to:
calculate a wavefield with an attenuated interface wave uₛ based on an attenuation term that describes a wave attenuation along a travelling direction, wherein the attenuated interface wave uₛ corresponds to a wave traveling along a low-velocity guide or along an interface between two different media and the travelling direction is aligned with the interface,
calculate an updated velocity model using (1) the wavefield corresponding to the attenuated interface wave uₛ and (2) a body wave wavefield u_{b}, and
generate an image of a subsurface based on the updated velocity model of the subsurface.

11. The system of claim 10, wherein the attenuation term is added (1) to the calculated wavefield in a model domain or (2) to wave equations for calculating the wavefield.

12. The system of claim 11, wherein the attenuated interface wave has an amplitude, a penetrating decay term, a phase term, and the attenuation term.

13. The system of claim 12, wherein the penetrating decay term is related to a spatial decay of the wave, along a penetrating depth direction substantially perpendicular to the interface, the phase term is related to a phase of the wave, and the attenuation term is related to a propagation path of the wave along the interface.

14. The system of claim 10, wherein the attenuation term is applied within a specified depth around the interface in the subsurface.

15. The system of claim 14, wherein the specified depth is where a maximum energy of the interface wave is entrapped.

16. The system of claim 10, wherein the body wave function describes one of a longitudinal wave, a transverse wave, a P-wave, or an S-wave, and the attenuated interface wave wavefield describes one of a surface wave, a ground-roll wave, a Love wave, a Rayleigh wave, a Stoneley wave, or a Scholte wave or a guided wave.

17. The system of claim 10, wherein the processor is further configured to:
pre-conditioning the recorded seismic data by suppressing an interface wave.

18. The system of claim 10, wherein the processor is further configured to:
compute forward propagated wavefields with attenuation of first specific waves within a desired depth, based on a source function;
compute an adjoint source according to a cost function;
backward propagate the adjoint source to calculate backward propagated wavefields with attenuation of second specific waves within the desired depth; and
update an initial velocity model to obtain the updated velocity model using a gradient obtained through a cross-correlation between the forward propagated wavefields and the backward propagated wavefields.

19. A non-transitory computer readable medium having stored thereon executable instructions that when executed by a processor of a computer control the computer to perform steps for inverting seismic data in elastic full waveform inversion (FWI), the steps comprising:
receive recorded seismic data;
calculate a wavefield with an attenuated interface wave uₛ based on an attenuation term that describes a wave attenuation along a travelling direction, wherein the attenuated interface wave uₛ corresponds to a wave traveling along a low-velocity guide or along an interface between two different media and the travelling direction is aligned with the interface;
calculate an updated velocity model using (1) the wavefield corresponding to the attenuated interface wave uₛ and (2) a body wave wavefield u_{b}; and
generate an image of a subsurface based on the updated velocity model of the subsurface.

20. The medium of claim 19, wherein the attenuation term is added (1) to the calculated wavefield in a model domain or (2) to wave equations for calculating the wavefield.
